(19) United States
(12) Patent Application Publication
(10) Pub. No.: US 2024/0387867 A1
(43) Pub. Date: Nov. 21, 2024

(54) Modified Electrolyte for All-Solid-State Batteries

(71) Applicant: Nissan North America, Inc., Franklin, TN (US)

(72) Inventors: Somayeh Zamani, Novi, MI (US); Mohammed Hussain Abdul Jabbar, Novi, MI (US)

(21) Appl. No.: 18/319,863

(22) Filed: May 18, 2023

(51) Int. Cl. H01M 10/0565

(52) U.S. Cl. CPC H01M 10/0565; H01M 2300/0085

(57) ABSTRACT

A modified electrolyte layer for an all-solid-state battery cell has solid electrolyte particles and a solid cross-linked polymer formed from a gel prepolymer that is polymerized in a first layer, and a second layer comprising the solid cross-linked polymer as an anode barrier layer on a surface of the first layer configured to face a lithium anode. The solid cross-linked polymer is impregnated in pores of the solid electrolyte particles in the first layer. The solid cross-linked polymer is coated on an exterior of each of the solid electrolyte particles in the first layer. The gel prepolymer comprises a methacrylate monomer containing silicon.

### TECHNICAL FIELD

This disclosure relates to a solid electrolyte for an all-solid-state battery that is modified with a gel polymer, the gel polymer filling voids in the solid electrolyte and coating solid electrolyte particles before it is solidified, providing an interface between the solid electrolyte and both of the lithium metal and the cathode active material.

### BACKGROUND

Advances have been made toward high energy density batteries, including both lithium metal and lithium-ion batteries. However, these advances are limited by the underlying choice of materials and electrochemistry. Traditional lithium-ion batteries either use organic liquid electrolytes, prone to negative reactions with active materials and potentially flammable, or ionic liquid electrolytes, with increased viscosities and lower ionic conductivity. All-solid-state batteries can address some or all of these issues, as well as produce higher energy densities. However, the large interfacial resistance at the electrolyte/electrode interface and the interfacial stability and compatibility due to lithium reactivity affect the electrochemical performance of batteries. Non-uniform lithium plating, formation of lithium dendrites and side reactions between lithium metal and the solid electrolyte contribute to the decrease in performance.

### SUMMARY

Disclosed herein are implementations of a modified electrolyte layer for an all-solid-state battery (ASSB) cell in which a gel prepolymer is mixed with solid electrolyte particles, filling pores of the solid electrolyte particles and coating each of the solid electrolyte particles prior to solidification and cross-linking to form a solid cross-linked polymer that is present in the pores and coated on the solid electrolyte particles.

In one implementation, a modified electrolyte layer for an ASSB cell has solid electrolyte particles and a solid cross-linked polymer formed from a gel prepolymer that is polymerized in a first layer, and a second layer comprising the solid cross-linked polymer as an anode barrier layer on a surface of the first layer configured to face a lithium anode. The solid cross-linked polymer is impregnated in pores of the solid electrolyte particles in the first layer. The solid cross-linked polymer is coated on an exterior of each of the solid electrolyte particles in the first layer. The gel prepolymer comprises a methacrylate monomer containing silicon.

Also disclosed herein are ASSB cells comprising the modified electrolyte layers disclosed herein. In one implementation, an ASSB cell comprises a cathode current collector, cathode active material adjacent the cathode current collector, an anode current collector, lithium metal adjacent the anode current collector, and a modified electrolyte layer between the lithium metal and the cathode active material. The modified electrolyte layer comprises solid electrolyte particles, each solid electrolyte particle having pores, a solid cross-linked polymer formed from a gel prepolymer that is polymerized, the solid crosslinked polymer in the pores of the solid electrolyte particles and forming a coating on an exterior of each solid electrolyte particle, and an anode barrier layer comprising the solid cross-linked polymer adjacent the lithium metal.

In another implementation, an ASSB cell comprises a cathode, a lithium metal anode, and a modified electrolyte layer between the lithium metal anode and the cathode. The modified electrolyte layer comprises solid electrolyte particles; and a solid cross-linked polymer formed from a gel prepolymer that is polymerized, the solid cross-linked polymer impregnated in pores of the solid electrolyte particles, coated on an exterior of the solid electrolyte particles, and in an anode barrier layer adjacent the lithium metal anode. The solid cross-linked polymer has a lower lithium ion conductivity than the solid electrolyte particles and is a physical barrier between lithium metal and the solid electrolyte particles.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a side view schematic of an ASSB cell with an enlargement of a modified electrolyte layer as disclosed herein.

FIG. 2 is a side view schematic of another ASSB cell with another embodiment of a modified electrolyte layer as disclosed herein.

FIG. 3 is a side view schematic of another ASSB cell with another embodiment of a modified electrolyte layer as disclosed herein.

FIG. 4 is a side view schematic of another ASSB cell with another embodiment of a modified electrolyte layer as disclosed herein.

FIG. 5 is a side view schematic of another ASSB cell with another embodiment of a modified electrolyte layer as disclosed herein.

### DETAILED DESCRIPTION

All-solid-state batteries (ASSBs) offer higher volumetric and gravimetric energy densities than conventional lithium-ion batteries. The lithium metal anode has a theoretical gravimetric capacity approximately ten times higher than graphite-based anodes. However, non-uniform electrodeposition of lithium, which results in dendrites, is holding back the widespread adoption of lithium metal batteries. During battery operation, lithium is continuously deposited or removed depending on charge/discharge cycles. As the lithium is deposited, it may not deposit uniformly, forming dendrites, which are tiny, rigid branch-like structures and needle-like projections. The formation of dendrites results in a non-uniform lithium surface which furthers non-uniform lithium deposition. As the dendrites grow from this non-uniform deposition, battery deterioration can occur. Contact between the solid electrolyte and the lithium metal can be lost, with gaps forming between the lithium and solid electrolyte. Both the low-density lithium dendrite deposition and the loss of contact between layers add to the cell expansion during charging. As the lithium dendrites reach the other electrode, short circuiting of the battery can occur. Also, side reactions between lithium metal and the solid electrolyte can further contribute to the decrease in performance.

To address these concerns, a modified electrolyte layer is disclosed for an ASSB cell in which a gel prepolymer is mixed with dry solid electrolyte particles, filling pores of the solid electrolyte particles and coating each of the solid electrolyte particles. The gel prepolymer is then solidified and cross-linked to form a solid cross-linked polymer that is present in the pores and coated on the solid electrolyte particles. The solid cross-linked polymer is lithium ion conductive, but less so that the solid electrolyte. The solid cross-linked polymer is not reactive with lithium. Because the cross-linked polymer is solid, it forms a physical barrier between the lithium metal and the solid electrolyte, eliminating the reactivity between the lithium metal and the solid electrolyte. A layer of the solid cross-linked polymer is also formed between the layer of coated solid electrolyte particles and the lithium metal anode to ensure adhesion between the layers and provide a uniform surface to ensure dense lithium plating. The solid cross-linked polymer also reduces or eliminates electrochemical instability between the solid electrolyte and the cathode active material, particularly when a sulfide-based solid electrolyte is used.

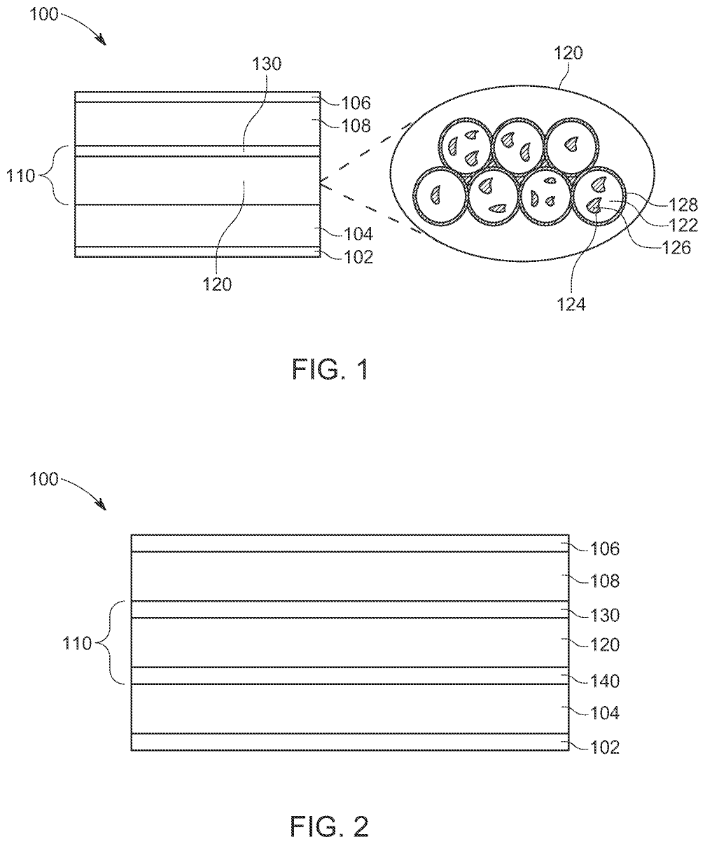

FIG. 1 is a schematic of an ASSB cell 100. The ASSB cell 100 has a cathode current collector 102, cathode active material 104 adjacent the cathode current collector 102, an anode current collector 106, lithium metal 108 adjacent the anode current collector 106, and a modified electrolyte layer 110 between the lithium metal 108 and the cathode active material 104.

The cathode current collector 102 can be, as non-limiting examples, an aluminum sheet or foil, carbon paper or graphene paper. The cathode active material 104 comprises one or more electrochemically active cathode materials known for use in solid-state batteries, such as lithium-containing oxide (e.g., lithium cobalt oxide (LiCoO₂), lithium manganese oxide (LiMnO₂), lithium nickel manganese cobalt oxide (LiNMC), lithium vanadium oxide (LiVO₂), lithium chromium oxide (LiCrO₂), lithium nickel oxide (LiNiO₂), lithium nickel cobalt aluminum oxide (LiNiCoAlO₂), and other transition metal oxides, or lithium iron phosphate (LiFePO₄)) and other similar materials. Other cathode active materials can be, but are not limited to, sulfur-based active materials including LiSO₂, LiSO₂Cl₂, LiSOCl₂, and LiFeS₂. The cathode active material 104 can also include one or both of a carbon material for electron conductivity and an electrolyte. A binder, such as a fiber, can also be included. As a non-limiting example, the cathode active material 104 can be a mixture of carbon, Li-NMC, a solid-state electrolyte and a fiber binder. The ratio of materials may be 80 Li-NMC/15 electrolyte/3 carbon/2 binder, as a non-limiting example.

The anode current collector 106 can be, as non-limiting examples, a sheet or foil of copper, nickel, a copper-nickel alloy, or a non-corrosive stainless steel. The lithium metal 108 can be a layer of elemental lithium metal, a layer of a lithium compound(s) or a layer of doped lithium.

In one implementation, the modified electrolyte layer 110 comprises a first layer 120 and a second layer 130. The first layer 120 is formed of solid electrolyte particles 122, each solid electrolyte particle 122 having pores 124, and a solid cross-linked polymer 126 which has filled the pores 124 of the solid electrolyte particles 122 and coated an exterior of each solid electrolyte particle 122, forming a coating 128 on each solid electrolyte particle 122. The second layer 130 of the modified electrolyte layer 110 is an anode barrier layer comprising the solid cross-linked polymer 126, the anode barrier layer being adjacent the lithium metal 108.

The modified electrolyte layer 110 is produced using dry solid electrolyte particles 122 and a gel prepolymer that has a low enough viscosity to impregnate the pores of the solid electrolyte particles and coat the solid electrolyte particles. The gel prepolymer may have a low enough viscosity to be considered a liquid prepolymer. The gel prepolymer is combined with an initiator, which can be added by weight as low as less than 0.5%, before being mixed with the solid electrolyte particles. The gel prepolymer mixed with the initiator and solid electrolyte particles is then cross-linked and solidified with an application of heat, for example. The cross-linking and solidification can occur after the entire ASSB cell 100 is assembled.

As discussed above, the material of the solid cross-linked polymer 126, and thus the gel prepolymer, is stable with lithium metal but has ionic conductivity. The solid cross-linked polymer 126 provides a physical barrier between the solid electrolyte particles and the lithium metal. As the solid cross-linked polymer is ionically conductive, but less so than the solid electrolyte particles, a dual path approach is created, with a fast conductive path through the solid electrolyte particles and a slow conductive path through the solid cross-linked polymer. The anode barrier layer (second layer 130) consisting of the solid cross-linked polymer provides a uniform bonding surface between the lithium metal and the coated solid electrolyte particles.

Examples of materials that can be employed as the solid electrolyte particles 122 include, but are not limited to, sulfur containing compounds and their derivatives, such as Argyrodites, Li₆PS₅Cl, Li₁₀GeP₂S₁₂ (LGPS), Li₇P₃S₁₁ (LPS), etc. Other chemistries that can be employed as the solid electrolyte include garnet structure oxides (e.g. Li₇La₃Zr₂O₁₂ (LLZO) with various dopants), NASICON-type phosphate glass ceramics such as Li_{1.5}Al_{0.5}Ti_{1.5} (PO₄)₃ (LATP), and oxynitrides (e.g. lithium phosphorus oxynitride or LIPON).

The initiator can be any initiator known to those skilled in the art. One non-limiting example is azobisisobutyronitrile (AIBN). The gel prepolymer, or gel monomer, can be a methacrylate monomer. The gel prepolymer may be one or more monomers modified with silicon to further improve the ionic conductivity, such as acrylate groups that contain silicon. Examples include poly (methacryloxypropyl) silsesquioxane (LPMASQ) and polyhedral oligomeric silsesquioxane-methacrylate (POSS-MA). Polyethylene glycol (PEG) can be added to provide ionic conductivity and adjust the viscosity of the prepolymer. The gel prepolymer may further have a stable radical double bonded to the monomer to provide electronic conductivity. One example of the stable radical is a nitroxide radical, which is stable due to delocalization of the unpaired electron on the N—O bond. (2,2,6,6,-tetramethylpiperidin-1-yl) oxyl (TEMPO) or its derivatives is one example. The stable radical can be in the form of vinyl ether or acrylate to provide the double bond needed for co-polymerization with the gel prepolymer.

In another implementation, the ASSB cell 100 may further include a cathode barrier layer 140 comprising the solid cross-linked polymer adjacent the cathode active material 104. The chemical, electrochemical and mechanical stabilities at the solid electrolyte-cathode active material interfaces can also present challenges. In particular, sulfide-based solid electrolytes have relatively poor intrinsic chemical and electrochemical stabilities against traditional cathode materials. Including the cathode barrier layer 140 reduces or eliminates the instabilities at this interface.

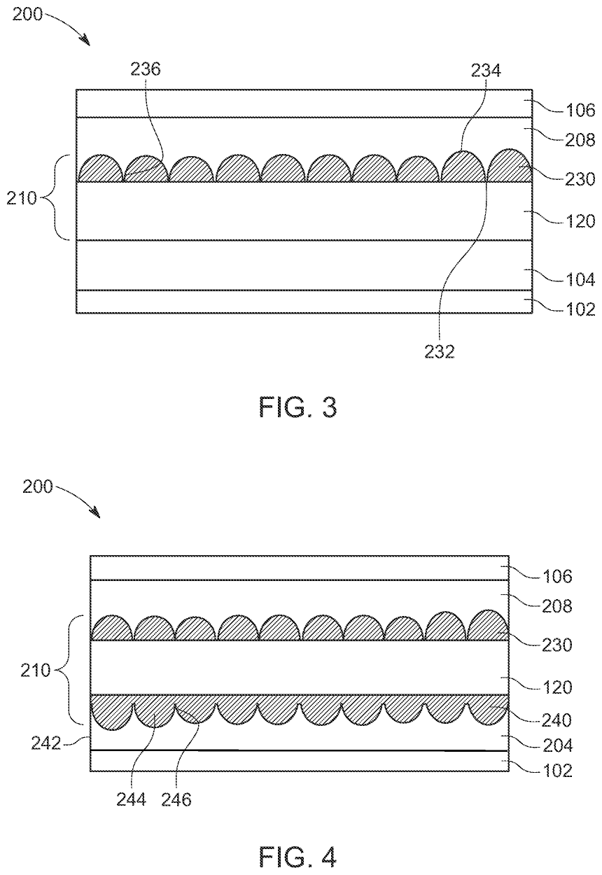

FIG. 3 is another implementation of a modified electrolyte layer as disclosed herein. In FIG. 3, elements that are identical to FIG. 1 share the same reference number. The ABBS cell 200 has a cathode current collector 102, cathode active material 104 adjacent the cathode current collector 102, an anode current collector 106, lithium metal 208 adjacent the anode current collector 106, and a modified electrolyte layer 210 between the lithium metal 208 and the cathode active material 104. The modified electrolyte layer 210 has a first layer 120 that is the same as that described with respect to FIG. 1. The modified electrolyte layer 210 also has a second layer 230; however, second layer 230 is different from second layer 130.

In the ASSB cell 200, the lithium metal 208 has an electrolyte-facing surface 232 in which are anode depressions 234. The anode depressions 234 modify the interface between the lithium metal and the solid cross-linked polymer, significantly increasing the surface area of the interface, providing more surface area for ion conduction. The term “anode depressions” indicates that there are concave depressions, carve-outs, or divots into the electrolyte-facing surface 232 of the lithium metal 208, with ridges 236 of lithium metal in between the anode depressions 234. The anode depressions 234 are relatively uniform in size and depth and spacing. The anode depressions 234 can be formed, as nonlimiting examples, by laser etching or by 3D printing. The anode depressions 234 are filled with the solid cross-linked polymer to form the second layer 230. During manufacture, the anode depressions 234 can be filled with the gel prepolymer and initiator and heated to cross-link and solidify. The heating can occur after the ASSB cell 200 layers are assembled.

FIG. 4 is a schematic of the ASSB cell 200 of FIG. 3 with the addition of the third layer 240, which differs from the third layer 140 of FIG. 1. In FIG. 4, the cathode active material 204 has an electrolyte-facing surface 242 in which are cathode depressions 244. The cathode depressions 244 modify the interface between the cathode active material and the solid cross-linked polymer, significantly increasing the surface area of the interface, providing more surface area for ion conduction. The term “cathode depressions” indicates that there are concave depressions, carve-outs, or divots into the electrolyte-facing surface 242 of the cathode active material 204, with ridges 246 of cathode active material 204 in between the cathode depressions 244. The cathode depressions 244 are relatively uniform in size and depth and spacing. The cathode depressions 244 can be formed, as nonlimiting examples, by laser etching or by 3D printing. The cathode depressions 244 are filled with the solid cross-linked polymer to form the third layer 240. During manufacture, the cathode depressions 244 can be filled with the gel prepolymer and initiator and heated to cross-link and solidify. The heating can occur after the ASSB cell 200 layers are assembled.

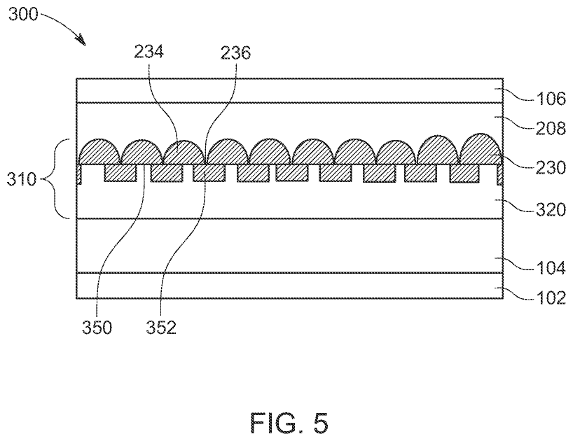

Another implementation is shown in FIG. 5. The ASSB cell 300 of FIG. 5 is the same of the ASSB cell 200 of FIG. 3 with a modification to first layer 320. The ABBS cell 300 has a cathode current collector 102, cathode active material 104 adjacent the cathode current collector 102, an anode current collector 106, lithium metal 208 adjacent the anode current collector 106, and a modified electrolyte layer 310 between the lithium metal 208 and the cathode active material 104. The modified electrolyte layer 310 has a second layer 230 that is the same as that described with respect to FIG. 3. The modified electrolyte layer 310 also has a first layer 320; however, first layer 320 is different from first layer 120.

As with the other implementations, the first layer 320 is formed of solid electrolyte particles, each solid electrolyte particle having pores, and a solid cross-linked polymer which has filled the pores of the solid electrolyte particles and coated an exterior of each solid electrolyte particle, forming a coating on each solid electrolyte particle. In this implementation, the first layer 320 is heated for cross-linking and solidification prior to assembly, forming a layer, so that an anode-facing surface 350 can be modified. The anode-facing surface 350 is modified with electrolyte depressions 352 formed to align with the lithium metal ridges 236 between the anode depressions 234. The electrolyte depressions 352 are filled with the solid cross-linked polymer, such that the solid cross-linked polymer aligns with the lithium metal ridges 236 between the anode depressions 234, providing further protection against reactivity and dendrite formation.

Persons skilled in the art will understand that the various embodiments of the disclosure described herein and shown in the accompanying figures constitute non-limiting examples, and that additional components and features may be added to any of the embodiments discussed herein above without departing from the scope of the present disclosure. Additionally, persons skilled in the art will understand that the elements and features shown or described in connection with one embodiment may be combined with those of another embodiment without departing from the scope of the present disclosure and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the disclosure, as are alternative embodiments that may result from combining, integrating, and/or omitting features from any of the disclosed embodiments.

Use of broader terms such as “comprises,” “includes,” and “having” should be understood to provide support for narrower terms such as “consisting of,” “consisting essentially of,” and “comprised substantially of.” Accordingly, the scope of protection is not limited by the description set out above but is defined by the claims that follow and includes all equivalents of the subject matter of the claims.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. An all-solid-state battery cell, comprising:
a cathode current collector;
cathode active material adjacent the cathode current collector;
an anode current collector;
lithium metal adjacent the anode current collector; and
a modified electrolyte layer between the lithium metal and the cathode active material, the modified electrolyte layer comprising:
solid electrolyte particles, each solid electrolyte particle having pores;
a solid cross-linked polymer formed from a gel prepolymer that is polymerized, the solid crosslinked polymer in the pores of the solid electrolyte particles and forming a coating on an exterior of each solid electrolyte particle; and
an anode barrier layer comprising the solid cross-linked polymer adjacent the lithium metal.

2. The all-solid-state battery cell of claim 1, wherein the gel prepolymer comprises a methacrylate monomer.

3. The all-solid-state battery cell of claim 2, wherein the methacrylate monomer contains silicon.

4. The all-solid-state battery cell of claim 3, wherein the methacrylate monomer is one or both of polyhedral oligomeric silsesquioxane-methacrylate (POSS-MA) or poly (methacryloxypropyl) silsesquioxane (LPMASQ).

5. The all-solid-state battery cell of claim 2, wherein the gel prepolymer further comprises a stable radical for electronic conductivity.

6. The all-solid-state battery cell of claim 5, wherein the stable radical is a nitroxide radical.

7. The all-solid-state battery cell of claim 1, wherein the modified electrolyte layer further comprises a cathode barrier layer comprising the solid cross-linked polymer adjacent the cathode active material.

8. The all-solid-state battery cell of claim 1, wherein the lithium metal has an electrolyte-facing surface in which are anode depressions, the solid cross-linked polymer of the anode barrier layer filling the anode depressions.

9. The all-solid-state battery cell of claim 8, wherein the solid electrolyte particles are in a layer having an anode-facing surface in which are electrolyte depressions, the electrolyte depressions containing the solid cross-linked polymer, the electrolyte depressions aligned such that the solid cross-linked polymer aligns with the lithium metal between the anode depressions.

10. The all-solid-state battery cell of claim 7, wherein the cathode active material has an electrolyte-facing surface in which are cathode depressions, the solid cross-linked polymer of the cathode barrier layer filling the cathode depressions.

11. A modified electrolyte layer for an all-solid-state battery cell, the modified electrolyte layer comprising:
a first layer comprising solid electrolyte particles and a solid cross-linked polymer formed from a gel prepolymer that is polymerized; and
a second layer comprising the solid cross-linked polymer as an anode barrier layer on a surface of the first layer configured to face a lithium anode, wherein:
the solid cross-linked polymer is impregnated in pores of the solid electrolyte particles in the first layer,
the solid cross-linked polymer is coated on an exterior of each of the solid electrolyte particles in the first layer, and
the gel prepolymer comprises a methacrylate monomer containing silicon.

12. The modified electrolyte layer for the all-solid-state battery cell of claim 11, wherein the methacrylate monomer is one or both of polyhedral oligomeric silsesquioxane-methacrylate (POSS-MA) or poly (methacryloxypropyl) silsesquioxane (LPMASQ).

13. The modified electrolyte layer for the all-solid-state battery cell of claim 11, wherein the gel prepolymer further comprises a stable radical for electronic conductivity.

14. The modified electrolyte layer for the all-solid-state battery cell of claim 13, wherein the stable radical is a nitroxide radical.

15. The modified electrolyte layer for the all-solid-state battery cell of claim 11, wherein the solid electrolyte particles are a sulfite-based electrolyte material, the modified electrolyte layer further comprising:
a third layer of the solid cross-linked polymer as a cathode barrier layer on a surface of the first layer configured to face a cathode.

16. An all-solid-state battery cell, comprising:
a cathode;
a lithium metal anode; and
a modified electrolyte layer between the lithium metal anode and the cathode, the modified electrolyte layer comprising:
solid electrolyte particles; and
a solid cross-linked polymer formed from a gel prepolymer that is polymerized, the solid cross-linked polymer impregnated in pores of the solid electrolyte particles, coated on an exterior of the solid electrolyte particles, and in an anode barrier layer adjacent the lithium metal anode,
wherein the solid cross-linked polymer has a lower lithium ion conductivity than the solid electrolyte particles and is a physical barrier between lithium metal and the solid electrolyte particles.

17. The all-solid-state battery cell of claim 16, wherein the gel prepolymer comprises a methacrylate monomer containing silicon.

18. The all-solid-state battery cell of claim 17, wherein the methacrylate monomer is one or both of polyhedral oligomeric silsesquioxane-methacrylate (POSS-MA) or poly (methacryloxypropyl) silsesquioxane (LPMASQ).

19. The all-solid-state battery cell of claim 16, wherein the modified electrolyte layer further comprises a cathode barrier layer comprising the solid cross-linked polymer adjacent the cathode.

20. The all-solid-state battery cell of claim 16, wherein the lithium metal anode has an electrolyte-facing surface in which are anode depressions, the solid cross-linked polymer of the anode barrier layer filling the anode depressions.
